(19) United States
(12) Patent Application Publication
(10) Pub. No.: US 2016/0020794 A1
(43) Pub. Date: Jan. 21, 2016

(54) EMBEDDED SPUR PROFILING

(71) Applicant: QUALCOMM Incorporated, San Diego, CA (US)

(72) Inventors: Anender SINGH, San Diego, CA (US); Taehyuk KANG, San Diego, CA (US)

(21) Appl. No.: 14/333,322

(22) Filed: Jul. 16, 2014

(51) Int. Cl. H04B 1/10; H04B 17/26; H04B 17/29

(52) U.S. Cl. CPC H04B 1/1027; H04B 17/29; H04B 17/26; H04B 2001/1072

(57) ABSTRACT

Disclosed are methods and apparatus for profiling and suppressing a receiver's internally-generated spurs. The disclosed methods and apparatus and populate a spur table in a wireless device without using external test equipment coupled to the wireless device. The disclosed methods and apparatus reduce testing time, reduce labor requirements, reduce test equipment costs, reduce spur table errors, and improve a receiver's sensitivity over conventional devices.

### FIELD OF DISCLOSURE

This disclosure relates generally to electronics, and more specifically, but not exclusively, to methods and apparatus that profile embedded spurs.

### BACKGROUND

A spurious signal, also known as a “spur” and a “birdie,” is an undesired signal that is unrelated to a received signal. Spurs can be generated internally in a receiver and can also come from an external interfering source. Internally-generated spurs are more prevalent than externally-generated spurs, and tend to be more of a problem than externally-generated spurs, due to the very close proximity of radio frequency (RF) circuits and digital circuits within an integrated circuit.

An internally-generated spur can be created within a receiver by different mechanisms, and typically appears at a deterministic frequency. Spurs can be generated by receiver components such as an oscillator, a synthesizer, a power management switching circuit, a display driver, etc. For example, a spur can be a harmonic of a receiver's reference oscillator, a harmonic of a sampling clock used to digitize a received signal, a harmonic of a clock used to clock a digital circuit in the receiver, an intermodulation product of a radio frequency component (e.g., a mixer), etc.

An externally-generated spur can occur in an RF signal received by the receiver's antenna. For example, an externally-generated spur can be a narrowband signal at a random frequency.

A spur can cause significant problems with adjusting an amplifier's gain, detecting a specific received signal, and decoding the specific received signal, because the spur can be present at a harmonic frequency near a frequency of the specific received signal. A spur can also fall within a bandwidth of the specific received signal. An in-band spur acts as noise, hindering the receiver's ability to properly demodulate the specific received signal—which in turn desenses the receiver. It is common for a receiver to have one or more “bad” frequency channels in which the receiver exhibits poor sensitivity due to an internally-generated spur. The resultant poor sensitivity leads to poor receiver performance, reduced communication coverage, and possibly other deleterious effects, all of which are undesirable. For example, the frequency modulated (FM) band, which in the Americas ranges from 87.9 MHz to 107.9 MHz, is impacted by clock spurs that are lower harmonics of many receivers. Mixing products of higher local oscillator frequencies can also impact FM receiver performance.

Different conventional techniques can mitigate a spur's effects. Generally, these techniques either cancel the spur or move the spur, so that the spur does not interfere with receiving information on a channel. Conventional spur mitigation techniques require evaluating each receiver to determine an exact frequency of each internally-generated spur, as well as and a bandwidth of each internally-generated spur, both of which vary by receiver. Evaluating the receiver typically includes injecting a swept signal into a receiver's antenna while performing either an end-to-end signal-to-noise ratio (SNR) measurement or monitoring a headset jack to detect a spur. Subsequently, a detected spur can be recorded in a spur look-up table, which is used by the receiver to suppress the identified internally-generated spur.

Conventional spur detection techniques are time intensive, labor intensive, and require expensive test equipment. Conventional spur detection techniques also rely on human effort, and are very susceptible to human error. Thus, despite best efforts, conventional spur detection techniques often result in the spur look-up table being incorrect.

Accordingly, there are long-felt industry needs for methods and apparatus that improve upon conventional methods and apparatus, including the improved methods and apparatus provided hereby.

### SUMMARY

This summary provides a basic understanding of some aspects of the present teachings. This summary is not exhaustive in detail, and is neither intended to identify all critical features, nor intended to limit the scope of the claims.

Exemplary methods and apparatus for profiling an internally-generated spur in a receiver are provided. An exemplary method includes tuning the receiver to a band, sweeping a radio frequency (RF) input of the receiver with an RF test signal that is internally-generated by the receiver, measuring, at a receiver output, a response of the receiver to the RF test signal over the band to identify an electrical characteristic of the spur, and storing, in a spur table, data describing the electrical characteristic. External test equipment need not be coupled to the receiver during the sweeping. The method can include isolating internal platform noise and the spur by terminating an RF antenna input to the receiver during the sweeping. The method can also include the RF test signal having a bandwidth of substantially 8 KHz and a frequency within a range from substantially 70 MHz to substantially 108 MHz. Further, the method can include disabling, during the sweeping and the measuring, at least one of a noise-generating component of the receiver, a spur-generating component of the receiver, or a frequency-generating component of the receiver. The data describing the electrical characteristic of the spur can include data identifying at least one of the spur's frequency, the spur's amplitude, the spur's bandwidth, a local oscillator frequency, or an affected channel. Further, the data describing the electrical characteristic can be stored in the spur table on a per-channel basis.

In a further example, provided is a non-transitory computer-readable medium, comprising instructions stored thereon that, if executed by a processor, such as a special-purpose processor, cause the processor to execute at least a part of the aforementioned method. The non-transitory computer-readable medium can be integrated with a device, such as at least one of an FM radio, a receiver, a mobile device, a music player, a video player, an entertainment unit, a navigation device, a communications device, a personal digital assistant (PDA), a fixed location data unit, or a computer.

In another example, provided is an apparatus configured to autonomously profile an internally-generated spur. The apparatus includes means for tuning the receiver to a band, means for sweeping a radio frequency (RF) input of the receiver with an RF test signal that is internally-generated by the receiver, means for measuring, at a receiver output, a response of the receiver to the RF test signal over the band to identify an electrical characteristic of the spur, and means for storing, in a spur table, data describing the electrical characteristic. The apparatus can include means for isolating internal platform noise and the spur by terminating an RF antenna input to the receiver during the sweeping. The RF test signal can have a bandwidth of substantially 8 KHz and a frequency within a range from substantially 70 MHz to substantially 108 MHz. The apparatus can further include means for disabling, during the sweeping and the measuring, at least one of a noise-generating component of the receiver, a spur-generating component of the receiver, or a frequency-generating component of the receiver. The data describing the electrical characteristic of the spur can include data identifying at least one of the spur's frequency, the spur's amplitude, the spur's bandwidth, a local oscillator frequency, or an affected channel. The data describing the electrical characteristic can be stored in the spur table on a per-channel basis.

At least a part of the apparatus can be integrated in a semiconductor die. Further, at least a part of the apparatus can be a part of a device, such as at least one of a mobile device, a set top box, a music player, a video player, an entertainment unit, a navigation device, a communications device, a personal digital assistant (PDA), a fixed location data unit, or a computer. In a further example, provided is a non-transitory computer-readable medium, comprising instructions stored thereon that, if executed by a lithographic device, cause the lithographic device to fabricate at least a part of the apparatus.

In another example, provided is an apparatus configured to autonomously profile an internally-generated spur. The apparatus includes a processor and a memory coupled to the processor. The memory stores processor-executable instructions configured to instruct the processor to control tuning the receiver to a band and sweeping a radio frequency (RF) input of the receiver with an RF test signal that is internally-generated by the receiver. The memory also stores processor-executable instructions configured to instruct the processor to control, measuring, at a receiver output, a response of the receiver to the RF test signal over the band to identify an electrical characteristic of the spur. The memory also stores processor-executable instructions configured to instruct the processor to control storing, in a spur table, data describing the electrical characteristic. The apparatus can further comprise a switch that is internal to the receiver and configured to terminate an RF antenna input to the receiver during the sweeping. The RF test signal can have a bandwidth of substantially 8 KHz and a frequency within a range from substantially 70 MHz to substantially 108 MHz. The processor-executable instructions can be configured to instruct the processor to control disabling, during the sweeping and the measuring, at least one of a noise-generating component of the receiver, a spur-generating component of the receiver, or a frequency-generating component of the receiver. The data describing the electrical characteristic of the spur can include data identifying at least one of the spur's frequency, the spur's amplitude, the spur's bandwidth, a local oscillator frequency, or an affected channel. Further, the data describing the electrical characteristic can be stored in the spur table on a per-channel basis.

At least a part of the apparatus can be integrated on a semiconductor die. Further, at least a part of the apparatus can include a device, such as at least one of a mobile device, a base station, a set top box, a music player, a video player, an entertainment unit, a navigation device, a communications device, a personal digital assistant (PDA), a fixed location data unit, or a computer, with a part of the apparatus being a constituent part of the device. In a further example, provided is a non-transitory computer-readable medium, comprising instructions stored thereon that, if executed by a lithographic device, cause the lithographic device to fabricate at least a part of the apparatus.

The foregoing broadly outlines some of the features and technical advantages of the present teachings in order that the detailed description and drawings can be better understood. Additional features and advantages are also described in the detailed description. The conception and disclosed examples can be readily utilized as a basis for modifying or designing other structures for carrying out the same purposes of the present teachings. Such equivalent constructions do not depart from the technology of the teachings as set forth in the claims. The inventive features that are characteristic of the teachings, together with further objects and advantages, are better understood from the detailed description and the accompanying figures. Each of the figures is provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an exemplary wireless communication network.

FIG. 2 depicts a functional block diagram of an exemplary user device.

FIG. 3 depicts an exemplary method for profiling an internally-generated spur in a receiver.

FIG. 4 depicts another exemplary method for profiling an internally-generated spur in a receiver.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

### Introduction

Methods and apparatus for profiling and suppressing internally-generated spurs in a receiver are disclosed. The disclosed techniques can be implemented in a wireless device, such as a wireless device in a wireless communication system. The techniques can improve a receiver's performance for some frequency channels by suppressing at least one internally-generated spur, while removing only a small portion of a desired signal.

The exemplary apparatuses and methods disclosed herein advantageously address the long-felt industry needs, as well as other previously unidentified needs, and mitigate shortcomings of the conventional methods and apparatus. For example, an advantage provided by the disclosed apparatuses and methods herein is an improvement in a receiver's sensitivity over conventional devices. Another advantage is a capability to populate a spur table in a wireless device under test without using external test equipment coupled to the wireless device. The exemplary apparatuses and methods disclosed herein reduce testing time, reduce labor requirements, reduce test equipment costs, and reduce spur table errors. Further, the disclosed techniques remove a need for special cables and radio frequency coupling devices, as some wireless devices such as cell phones do not have an external radio frequency connector for cabled measurements.

Examples are disclosed in this application's text and drawings. Alternate examples can be devised without departing from the scope of the invention. Additionally, conventional elements of the current teachings may not be described in detail, or may be omitted, to avoid obscuring aspects of the current teachings.

As used herein, the term “exemplary” means “serving as an example, instance, or illustration.” Any example described as “exemplary” is not necessarily to be construed as preferred or advantageous over other examples. Likewise, the term “examples of the invention” does not require that all examples of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

It should be noted that the terms “connected,” “coupled,” and any variant thereof, mean any connection or coupling between elements, either direct or indirect, and can encompass a presence of an intermediate element between two elements that are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like. These are several non-limiting and non-exhaustive examples.

The term “signal” can include any signal such as a data signal, an audio signal, a video signal, a multimedia signal, an analog signal, a digital signal, and the like. Information can be represented using any of a variety of different technologies and techniques. For example, data, an instruction, a process step, a command, information, a signal, a bit, a symbol, and the like can be represented by a voltage, a current, an electromagnetic wave, a magnetic field, a magnetic particle, an optical field, and optical particle, and any combination thereof.

A reference using a designation such as “first,” “second,” and so forth does not limit either the quantity or the order of those elements. Rather, these designations are used as a convenient method of distinguishing between two or more elements. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims can be interpreted as “A or B or C or any combination of these elements.”

The terminology used herein is for the purpose of describing particular examples only and is not intended to be limiting. As used herein, the singular forms “a,” “an,” and “the” include the plural forms as well, unless the context clearly indicates otherwise. Further, the terms “comprises,” “comprising,” “includes,” and “including,” specify a presence of a feature, an integer, a step, an operation, an element, a component, and the like, but do not necessarily preclude a presence or an addition of another feature, integer, step, operation, element, component, and the like.

The term “wireless device” can describe, and is not limited to, a radio frequency receiver, an FM radio, an AM radio, a mobile device, a mobile phone, a mobile communication device, a personal digital assistant, a personal information manager, a mobile hand-held computer, a portable computer, an audio device, a wireless modem, and/or other types of portable electronic devices typically carried by a person and having communication capabilities (e.g., wireless, cellular, infrared, short-range radio, etc.). Further, the terms “user equipment” (UE), “mobile terminal,” “mobile device,” “receiver,” and “wireless device” can be interchangeable.

### Description of the Figures

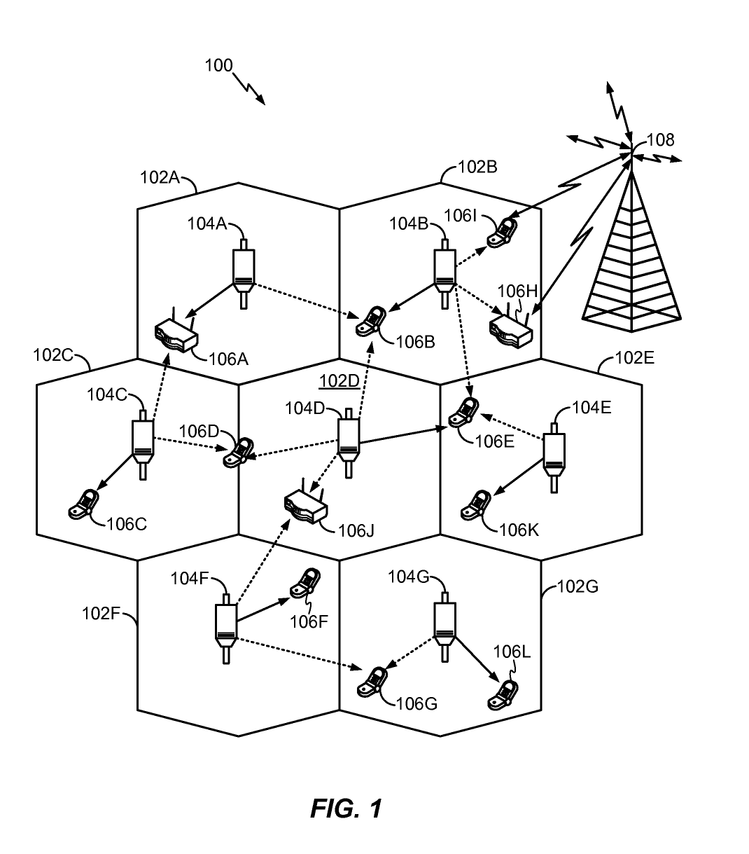

FIG. 1 depicts an exemplary wireless communication network 100 to demonstrate principles of multiple access communication and integrated receivers. The wireless communication network 100 is configured to support communication between multiple users. As shown, the wireless communication network 100 can be divided into one or more cells 102A-102G. Communication coverage in cells 102A-102G can be provided by one or more access points 104A-104G. Thus, each access point 104A-104G can provide communication coverage to a corresponding cell 102A-102G. The access points 104A-104G can interact with at least one user device in a plurality of user devices 106A-106L.

A broadcast receiver can be integrated in at least one user device in the plurality of user devices 106A-106L. The broadcast receiver can receive and demodulate broadcast signals transmitted from a broadcast antenna 108, such as frequency modulated (FM) broadcast radio, which in the Americas has carrier frequencies ranging from 87.9 MHz to 107.9 MHz.

Each user device 106A-106L can communicate with one or more of the access points 104A-104G on a downlink (DL) and/or an uplink (UL). In general, a DL is a communication link from an access point to a user device, while a UL is a communication link from a user device to an access point. The access points 104A-104G can be coupled via wired or wireless interfaces, allowing the access points 104A-104G to communicate with each other and/or other network equipment. Accordingly, each user device 106A-106L can also communicate with another user device 106A-106L via one or more of the access points 104A-104G. For example, the user device 106J can communicate with the user device 106H in the following manner: the user device 106J can communicate with the access point 104D, the access point 104D can communicate with the access point 104B, and the access point 104B can communicate with the user device 106H, allowing communication to be established between the user device 106J and the user device 106H.

The wireless communication network 100 can provide service over a large geographic region. For example, the cells 102A-102G can cover a few blocks within a neighborhood or several square miles in a rural environment. In some systems, each cell can be further divided into one or more sectors (not shown). In addition, the access points 104A-104G can provide the user devices 106A-106L within their respective coverage areas with access to other communication networks, such as the Internet, another cellular network, and the like. In the example shown in FIG. 1, the user devices 106A, 106H, and 106J comprise routers, while the user devices 106B-106G, 106I, 106K, and 106L comprise mobile phones. However, each of the user devices 106A-106L can comprise any suitable communication device.

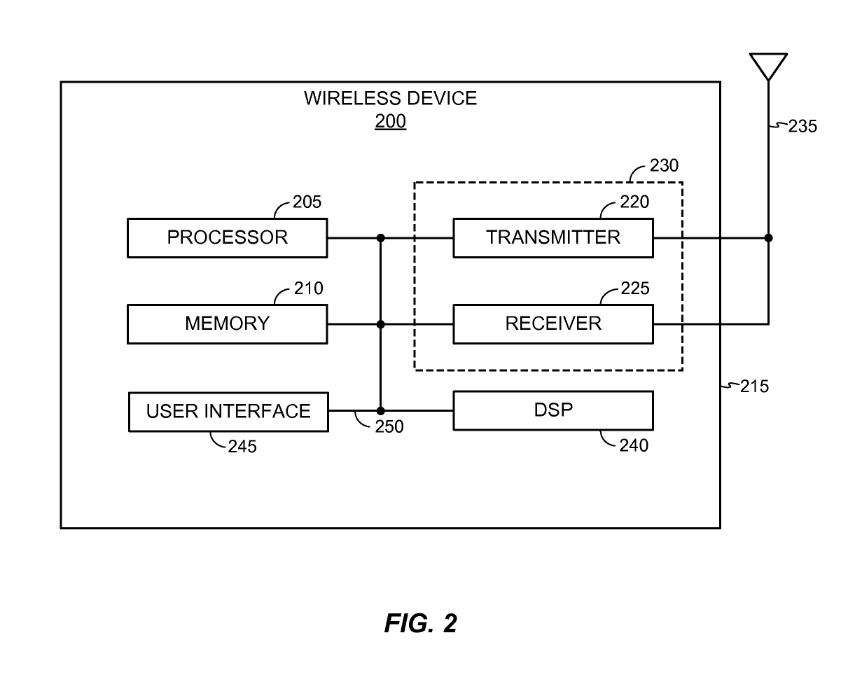

FIG. 2 depicts a functional block diagram of an exemplary user device 200, which can correspond to at least one of the user devices 106A-106L. FIG. 2 also depicts different components that can be implemented in the user device 200. The user device 200 is an example of a device that can be configured to include the apparatus described herein.

The user device 200 can include a processor 205 which is configured to control operation of the user device 200. The processor 205 can also be referred to as a central processing unit (CPU) and as a special-purpose processor. A memory 210, which can include at least one of read-only memory (ROM) or random access memory (RAM) provides instructions and data to the processor 205. A portion of the memory 210 can also include non-volatile random access memory (NVRAM). The processor 205 performs logical and arithmetic operations based on program instructions stored within the memory 210. The instructions in the memory 210 can be executable to implement at least a part of a method described herein.

The processor 205 can comprise and/or be a component of a processing system implemented with one or more processors. The one or more processors can be implemented with a microprocessor, a microcontroller, a digital signal processor (DSP), a field programmable gate array (FPGA), a programmable logic device (PLD), a controller, a state machine, gated logic, a discrete hardware component, a dedicated hardware finite state machine, and/or any other suitable entity that can manipulate information.

The processing system can also include a non-transitory machine-readable media (e.g., the memory 210) that stores software. Software can mean any type of instructions, whether referred to as software, firmware, middleware, microcode, hardware description language, and/or otherwise. Instructions can include code (e.g., in source code format, binary code format, executable code format, or any other suitable format of code). The instructions, when executed by the processor 205, can transform the processor 205 into a special-purpose processor that causes the processor to perform a function described herein.

The memory 210 can store processor-executable instructions configured to instruct the processor to control sweeping an radio frequency (RF) input of the receiver with an RF test signal that is internally-generated by the receiver, measuring, at a receiver output, a response of the receiver to the RF test signal to identify an electrical characteristic of a spur, and storing, in a spur table, data describing the electrical characteristic. The RF test signal can have a bandwidth of substantially 8 KHz and a frequency within a range from substantially 70 MHz to substantially 108 MHz. The processor-executable instructions can be configured to instruct the processor to control disabling, during the sweeping and the measuring, at least one of: a signal frequency-generating component of the receiver or a signal frequency-modifying component of the receiver. The data describing the electrical characteristics of the spur can include at least one of the spur's frequency, the spur's amplitude, the spur's bandwidth, a local oscillator frequency, an affected channel (e.g., a channel identifier), or the like. The measurement results can be stored in the spur table on a per-channel basis.

The user device 200 can also include a housing 215, a transmitter 220, and a receiver 225 to allow transmission and reception of data between the user device 200 and a remote location. The transmitter 220 and receiver 225 can be combined into a transceiver 230. An antenna 235 can be attached to the housing 225 and electrically coupled to the transceiver 230. The user device 200 can also include (not shown) multiple transmitters, multiple receivers, multiple transceivers, and/or multiple antennas.

The receiver 225 can be configured to receive (e.g., from the broadcast antenna 108) and demodulate a broadcast signal such as a frequency modulated (FM) broadcast signal. For example, the FM broadcast signal is in an FM band (e.g., within a range from substantially 70 MHz to substantially 108 MHz, such as from 87.9 MHz to 107.9 MHz). The receiver 225 can include a switch that is a part of the user device 200 (e.g., internal to the receiver) and configured to terminate an RF antenna input from the antenna 235 to the user device 200 (e.g., the receiver 225) during the sweeping.

The user device 200 can further comprise a digital signal processor (DSP) 240 that is configured to process data. The user device 200 can also further comprise a user interface 245. The user interface 245 can comprise a keypad, a microphone, a speaker, and/or a display. The user interface 245 can include any element and/or component that conveys information to a user of the user device 200 and/or receives input from the user.

The components of the user device 200 can be coupled together by a bus system 250. The bus system 250 can include a data bus, for example, as well as a power bus, a control signal bus, and/or a status signal bus in addition to the data bus. The components of the user device 200 can be coupled together to accept and/or provide inputs to each other using a different suitable mechanism.

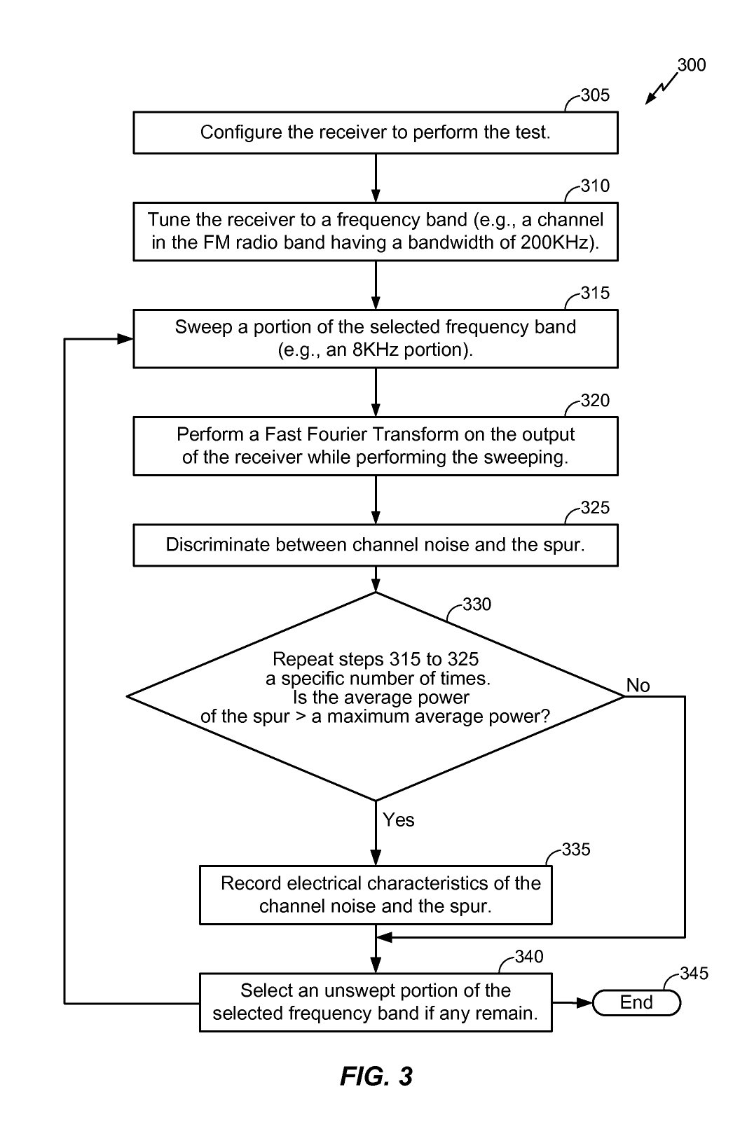

FIG. 3 depicts an exemplary method 300 for profiling an internally-generated spur in a receiver. The method 300 can be performed by the apparatus described hereby, such as at least one user device in the plurality of user devices 106A-106L and the user device 200.

In block 305, the receiver is configured to perform the test. Configuring can include determining a frequency band to be swept and a noise floor. A spur table can be used to identify a portion of the selected frequency band to use as an initial frequency range. Configuring can include configuring an audio codec path by playing an audio tone (e.g., a 1 KHz tone via an MP3 path) to be detected at a receiver output. Configuring can also include setting an audio volume level to a specific level, turning a user display on or off, setting a user display brightness level if a user display is enabled, as well as enabling other components in the receiver (e.g., a wireless local area network device, a Bluetooth device, a near field communication device, a wide area network device, and the like). These other components in the receiver may generate a spur, so enabling or disabling these other components can assist identifying a source of a spur. Further, a flag may be set to indicate that electrical characteristics of a spur are to be stored in the spur table.

In block 310, the receiver is tuned to the frequency band. For example, the frequency band can include an FM channel in a range from substantially 70 MHz to substantially 108 MHz (e.g., at least a portion of the FM radio band).

In block 315, a portion of the selected frequency band (e.g., an 8 KHz portion of the selected FM channel) is swept with an RF test signal that is internally-generated by the receiver.

In block 320, a Fast Fourier Transform (FFT) is performed on the output of the receiver while performing the sweeping. If a candidate spur is present, the FFT result represents the candidate spur's peak amplitude and noise floor for the range of specified frequencies in the portion of the selected frequency band.

In block 325, the FFT result is analyzed to discriminate between channel noise and the candidate spur, in order to identify a presence of the candidate spur and the candidate spur's electrical characteristics (e.g., frequency, bandwidth, amplitude, and the like). When compared to noise, a candidate spur is present more often at substantially a constant frequency, and has amplitude exceeding that of the average channel noise. In an example, the number of identified candidate spurs is limited (e.g., zero to two spurs).

In block 330, blocks 315 through 325 are repeated a specified number of times (e.g., 25 repetitions) to identify average electrical characteristics of the candidate spur. Repeating blocks 310 through 325 multiple times determines an average that removes channel noise from the measured electrical characteristics of the candidate spur, and improves accuracy of the spur table. In an example, an FM channel having a 200 KHz bandwidth has 25 portions of the selected frequency band to be swept, and thus requires 25 iterations of blocks 315 to 325. After blocks 310 through 325 are repeated the specified number of times, the average power of the candidate spur is calculated from the multiple results of block 325. If the average power of the candidate spur is greater than a threshold that is a function of average power, then the candidate spur is identified as a confirmed spur to be mitigated. If yes, then the method 300 proceeds to block 335. If no, then the method 300 proceeds to block 340.

In block 335, electrical characteristics of channel noise and the confirmed spur are recorded. For example, data describing the electrical characteristic of the confirmed spur is stored in a spur table. The data describing the electrical characteristics of the confirmed spur can include at least one of the confirmed spur's frequency, the confirmed spur's amplitude, the confirmed spur's bandwidth, a local oscillator frequency, or an affected channel. The measurement results can be stored in the spur table on a per-channel basis.

In block 340, if the entirety of the frequency band has not been swept, then an unswept portion of the selected frequency band (e.g., another 8 KHz portion of the selected channel) is selected to be swept, and the method 300 proceeds to block 315. If the entire frequency band has been swept, then the method 300 proceeds to block 345.

In block 345, the method 300 ends.

Subsequent to performing the method 300, a processor can filter the digital samples of the receiver output with a notch filter having at least one of an adjustable notch frequency or an adjustable notch bandwidth. For example, the notch frequency can be set based on the frequency of the confirmed spur, and the notch bandwidth can be set based on the frequency content (e.g., a bandwidth) of the confirmed spur.

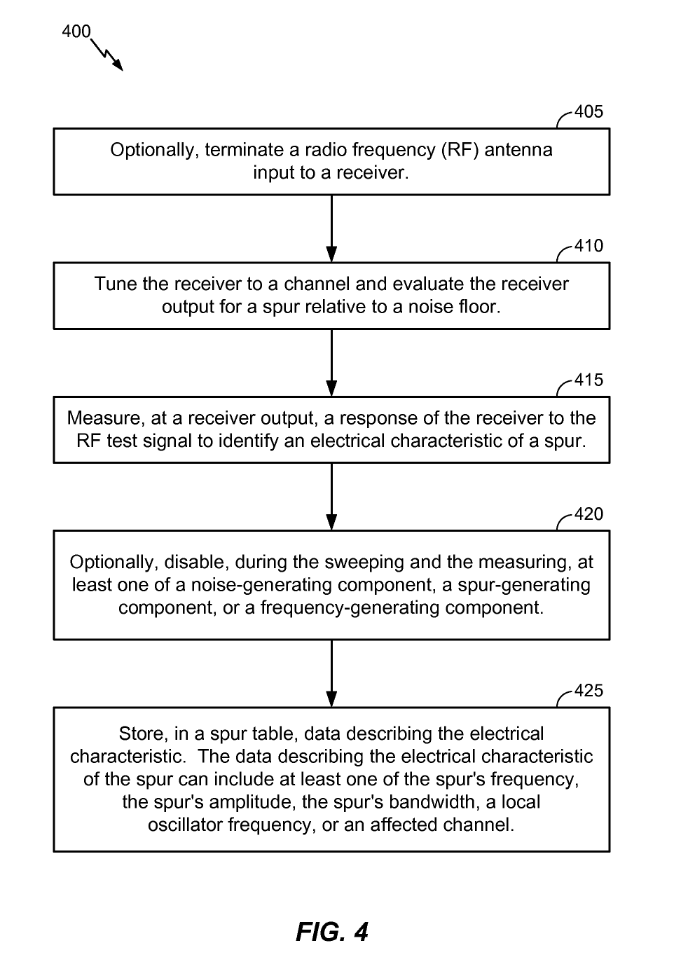

FIG. 4 depicts another exemplary method 400 for identifying and profiling an internally-generated spur in a receiver. The method 400 can be performed by at least one apparatus described hereby, such as at least one user device in the plurality of user devices 106A-106L or the user device 200.

In block 405, an RF antenna input to the receiver can be terminated to keep broadcast signals and other RF interference out of the receiver. The termination can start before block 410, and can continue during at least a part of block 410. In an example, a shield box is used if a termination switch inside the receiver is not available. In a shielded environment, an antenna (e.g., a headset antenna) can be enabled to isolate radiated spurs at a platform level.

In block 410, the receiver is tuned to a channel and the receiver output is evaluated for a presence of a spur relative to a noise floor, as no broadcast or test RF signal is input to the receiver. In an example, no test signal is generated while executing the method 400. A signal evaluated in this example can have a bandwidth of substantially 8 KHz and an RF frequency within a range from substantially 70 MHz to substantially 108 MHz.

In block 415, a response of the receiver is measured at a receiver output to identify an electrical characteristic of a spur.

In optional block 420, during block 410 and block 415, at least one of a noise-generating component, a spur-generating component, or a frequency-generating component which could be a source of noise or spur is disabled. Selectively disabling at least one of a noise-generating component, a spur-generating component, or a frequency-generating component while performing the measuring in block 415 can assist in identifying at least one specific component in the receiver that is causing the spur.

In block 425, data describing the electrical characteristic is stored in a spur table. The data describing the electrical characteristics of the spur can include at least one of the spur's frequency, the spur's amplitude, the spur's bandwidth, a local oscillator frequency, or an affected channel. The measurement results can be stored in the spur table on a per-channel basis.

Optionally, external test equipment is not coupled to the receiver during blocks 410-425.

The blocks in FIGS. 3-4 are not limiting of the various examples. The blocks can be at least one of combined or the order rearranged to achieve embedded spur profiling.

Further, those of skill in the art will appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In some aspects, the teachings herein can be employed in a multiple-access system capable of supporting communication with multiple users by sharing the available system resources (e.g., by specifying one or more of bandwidth, transmit power, coding, interleaving, and so on). For example, the teachings herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure can be described using 3GPP terminology, it is to be understood that the teachings herein can be applied to 3GPP (e.g., Rel99, Rel5, Rel6, Rel7) technology, as well as 3GPP2 (e.g., 1×RTT, 1×EV-DO RelO, RevA, RevB) technology and other technologies. The techniques can be used in emerging and future networks and interfaces, including Long Term Evolution (LTE).

At least a portion of the methods, sequences, and/or algorithms described in connection with the examples disclosed herein can be embodied directly in hardware, in software executed by a processor, or in a combination of the two. In an example, a processor includes multiple discrete hardware components. A software module may reside in RAM memory, flash memory, ROM memory, EPROM memory, EEPROM memory, registers, hard disk, a removable disk, a CD-ROM, and/or any other form of storage medium known in the art. An exemplary storage medium (e.g., a memory) can be coupled to the processor such that the processor can read information from, and write information to, the storage medium. In an alternative, the storage medium may be integral with the processor.

Further, many examples are described in terms of sequences of actions to be performed by, for example, elements of a computing device. The actions described herein can be performed by a specific circuit (e.g., an application specific integrated circuit (ASIC)), by program instructions being executed by one or more processors, or by a combination of both. Additionally, a sequence of actions described herein can be considered to be embodied entirely within any form of computer readable storage medium having stored therein a corresponding set of computer instructions that upon execution would cause an associated processor (such as a special-purpose processor) to perform at least a portion of a function described herein. Thus, the various aspects of the invention may be embodied in a number of different forms, all of which have been contemplated to be within the scope of the claimed subject matter. In addition, for each of the examples described herein, a corresponding circuit of any such examples may be described herein as, for example, “logic configured to” perform a described action.

An example of the invention can include a computer readable media embodying a method described herein. Accordingly, the invention is not limited to illustrated examples and any means for performing the functions described herein are included in examples of the invention.

The disclosed devices and methods can be designed and can be configured into a computer-executable file that is in a Graphic Database System Two (GDSII) compatible format, an Open Artwork System Interchange Standard (OASIS) compatible format, and/or a GERBER (e.g., RS-274D, RS-274X, etc.) compatible format, which are stored on a non-transitory (i.e., a non-transient) computer-readable media. The file can be provided to a fabrication handler who fabricates with a lithographic device, based on the file, an integrated device. Deposition of a material to form at least a portion of a structure described herein can be performed using deposition techniques such as physical vapor deposition (PVD, e.g., sputtering), plasma-enhanced chemical vapor deposition (PECVD), thermal chemical vapor deposition (thermal CVD), and/or spin-coating. Etching of a material to form at least a portion of a structure described herein can be performed using etching techniques such as plasma etching. In an example, the integrated device is on a semiconductor wafer. The semiconductor wafer can be cut into a semiconductor die and packaged into a semiconductor chip. The semiconductor chip can be employed in a device described herein (e.g., a mobile device).

Examples can include a non-transitory (i.e., a non-transient) machine-readable media and/or a non-transitory (i.e., a non-transient) computer-readable media embodying instructions which, when executed by a processor (such as a special-purpose processor), transform a processor and any other cooperating devices into a machine (e.g., a special-purpose processor) configured to perform at least a part of a function described hereby and/or transform a processor and any other cooperating devices into at least a part of the apparatus described hereby.

Nothing stated or illustrated depicted in this application is intended to dedicate any component, step, feature, object, benefit, advantage, or equivalent to the public, regardless of whether the component, step, feature, object, benefit, advantage, or the equivalent is recited in the claims.

While this disclosure describes examples of the invention, it should be noted that various changes and modifications could be made herein without departing from the scope of the invention as defined by the appended claims.

1. A method for profiling an internally-generated spur in a receiver, comprising:
tuning the receiver to a band;
sweeping a radio frequency (RF) input of the receiver with an RF test signal that is internally-generated by the receiver;
isolating internal platform noise and the internally-generated spur by terminating an RF antenna input to the receiver, during the sweeping, to keep broadcast signals and other RF interference out of the receiver;
measuring, at a receiver output, a response of the receiver to the RF test signal over the band to identify an electrical characteristic of the internally-generated spur; and
storing, in a spur table, data describing the electrical characteristic.

2. The method of claim 1, wherein external test equipment is not coupled to the receiver during the sweeping.

3. (canceled)

4. The method of claim 1, wherein the RF test signal has a bandwidth of substantially 8 KHz and a frequency within a range from substantially 70 MHz to substantially 108 MHz.

5. The method of claim 1, further comprising disabling, during the sweeping and the measuring, at least one of a noise-generating component of the receiver, a spur-generating component of the receiver, or a frequency-generating component of the receiver.

6. The method of claim 1, wherein the data describing the electrical characteristic of the internally-generated spur includes data identifying at least one of the spur's frequency, the spur's amplitude, the spur's bandwidth, a local oscillator frequency, or an affected channel.

7. The method of claim 1, wherein the data describing the electrical characteristic is stored in the spur table on a per-channel basis.

8. A receiver configured to autonomously profile an internally-generated spur, comprising:
means for tuning the receiver to a band;
means for sweeping a radio frequency (RF) input of the receiver with an RF test signal that is internally-generated by the receiver;
means for isolating internal platform noise and the internally-generated spur by terminating an RF antenna input to the receiver, during the sweeping, to keep broadcast signals and other RF interference out of the receiver;
means for measuring, at a receiver output, a response of the receiver to the RF test signal over the band to identify an electrical characteristic of the internally-generated spur; and
means for storing, in a spur table, data describing the electrical characteristic.

9. (canceled)

10. The receiver of claim 8, wherein the RF test signal has a bandwidth of substantially 8 KHz and a frequency within a range from substantially 70 MHz to substantially 108 MHz.

11. The receiver of claim 8, further comprising means for disabling, during the sweeping and the measuring, at least one of a noise-generating component of the receiver, a spur-generating component of the receiver, or a frequency-generating component of the receiver.

12. The receiver of claim 8, wherein the data describing the electrical characteristic of the internally-generated spur includes data identifying at least one of the spur's frequency, the spur's amplitude, the spur's bandwidth, a local oscillator frequency, or an affected channel.

13. The receiver of claim 8, wherein the data describing the electrical characteristic is stored in the spur table on a per-channel basis.

14. A receiver configured to autonomously profile an internally-generated spur, comprising:
a processor;
a memory coupled to the processor and storing processor-executable instructions configured to instruct the processor to control:
tuning the receiver to a band;
sweeping a radio frequency (RF) input of the receiver with an RF test signal that is internally-generated by the receiver;
measuring, at a receiver output, a response of the receiver to the RF test signal over the band to identify an electrical characteristic of the internally-generated spur; and
storing, in a spur table, data describing the electrical characteristic; and
a switch that is internal to the receiver and configured to terminate an RF antenna input to the receiver, during the sweeping, to keep broadcast signals and other RF interference out of the receiver.

15. (canceled)

16. The receiver of claim 14, wherein the RF test signal has a bandwidth of substantially 8 KHz and a frequency within a range from substantially 70 MHz to substantially 108 MHz.

17. The receiver of claim 14, wherein the processor-executable instructions are configured to instruct the processor to control disabling, during the sweeping and the measuring, at least one of a noise-generating component of the receiver, a spur-generating component of the receiver, or a frequency-generating component of the receiver.

18. The receiver of claim 14, wherein the data describing the electrical characteristic of the internally-generated spur includes data identifying at least one of the spur's frequency, the spur's amplitude, the spur's bandwidth, a local oscillator frequency, or an affected channel.

19. The receiver of claim 14, wherein the data describing the electrical characteristic is stored in the spur table on a per-channel basis.
